(19) United States
(12) Patent Application Publication
(10) Pub. No.: US 2009/0273467 A1
(43) Pub. Date: Nov. 5, 2009

(54) IP BASED MONITORING AND ALARMING

(75) Inventors: Martin Elixmann, Aachen (DE); Javier Espina, Aachen (DE); Thomas Falck, Aachen (DE)

Correspondence Address: PHILIPS INTELLECTUAL PROPERTY & STANDARDS, P. O. Box 3001, BRIARCLIFF MANOR, NY, 10510, US

(73) Assignee: KONINKLIJKE PHILIPS ELECTRONICS N. V., Eindhoven (NL)

(21) Appl. No.: 12/441,400

(22) PCT Filed: Sep. 10, 2007
(86) PCT No.: PCT/US07/77981

§ 371 Date: Mar. 16, 2009

Related U.S. Application Data
(60) Provisional application No. 60/825,957, filed on Sep. 18, 2006.

(51) Int. Cl. G08B 1/08

(52) U.S. Cl. 340/539.12

(57) ABSTRACT

A patient monitoring system (8) monitors health related parameters of a patient (10). A medical device (12) obtains measurements of the health related parameters of the patient (10). A first mobile device (16), associated with the patient (10), wirelessly collects and transmits the health related parameters of the patient (10). A second mobile device (22), in operative communication with first mobile device, receives the transmitted health related parameters of the patient.

The present application relates to monitoring arts. It finds particular application in relation to patient monitoring at the hospital and will be described with particular reference thereto. However, it is to be appreciated that the following will also find application in conjunction with patient monitoring in retirement communities, assisted living, pharmacies, community centers, at home, and the like.

Typically, in-hospital patient monitoring is based on wired connections to measure vital parameters of the patient. More specifically, in telemetry monitoring systems, the patient is provided with a set of sensors. The sensors are typically wired to a Patient Worn device (PWD), which is equipped with an infrastructure-based radio technology (e.g. DECT or WLAN). The PWD wirelessly transmits the patient's vital parameters to the one of the access points of the wireless infrastructure. Once at the access point, the data is forwarded over cable to the nurse station or a patient information center, where medical staff monitors the patient's vital parameters. However, the telemetry monitoring systems are expensive. In case of a critical situation, the physician receives a pager alarm from the nurse station and has to be present at either the patient side or the nurse station to evaluate the situation.

In other monitoring systems, the sensors, which are attached to the patient, form a Body Sensor Network (BSN) that communicates wirelessly to the bedside monitor in the proximity of the patient. Examples of a short-range wireless technology that can be used in such systems are Bluetooth, IEEE 802.15.4/ZigBee, and the like. The body sensor networks are typically deployed in intensive care units where patients are near a bedside monitor. The BSN cannot be used, unless combined with other wireless technologies, to monitor moving patients. Further, similar to the telemetry monitoring systems, the BSN concept does not integrate the physician in the system.

One approach is to provide physicians with an IP-enabled mobile phone such as Cisco Wireless IP Phone 7920 that displays real-time vital parameters of the patient independently of the physicians location as long as the attending physician remains within the hospital wireless infrastructure. In such systems, the physicians can receive alarms about a potentially hazardous, change in the patient's vital parameters and examine the patient's vital parameters without the need to be physically present at the nurse station or the bedside monitor. The IP monitoring solution enables the mobility of the medical staff within the hospital and optimizes efficiency. Nevertheless the system does not provide patients with mobility nor free them from obtrusive sensor wiring.

The present application provides new and improved methods and apparatuses which overcome the above-referenced problems and others.

In accordance with one aspect, a patient monitoring system which monitors health related parameters of a patient is disclosed. A medical device obtains measurements of the health related parameters of the patient. A first mobile device, coupled with the patient, wirelessly collects and transmits the health related parameters of the patient. A second mobile device, in operative communication with first mobile device, receives the transmitted health related parameters of the patient.

In accordance with another aspect, a method for monitoring a patient is disclosed. Wireless first and second mobile devices are assigned to a patient and a medical clinician. The first mobile device is associated to a medical measurement device which is linked to a corresponding patient. A health related parameter of the patient is measured with the medical measurement device. The results of the measurements are collected with the first mobile device. The results of the measurements of the patient are transmitted to the second mobile device.

In accordance with another aspect, a patient monitoring system for monitoring health related parameters of a patient is disclosed. A medical device obtains measurements of the health related parameters of the patient. A first mobile device is associated with the patient, for wirelessly collecting and transmitting the health related parameters of the patient for review. A second mobile device is in operative communication and associated with the first mobile device and a clinician, for receiving the transmitted health related parameters of the patient.

One advantage is that physicians wirelessly receive and monitor the patient's measurement data.

Still further advantages of the present invention will be appreciated to those of ordinary skill in the art upon reading and understand the following detailed description.

The invention may take form in various components and arrangements of components, and in various steps and arrangements of steps. The drawings are only for purposes of illustrating the preferred embodiments and are not to be construed as limiting the invention.

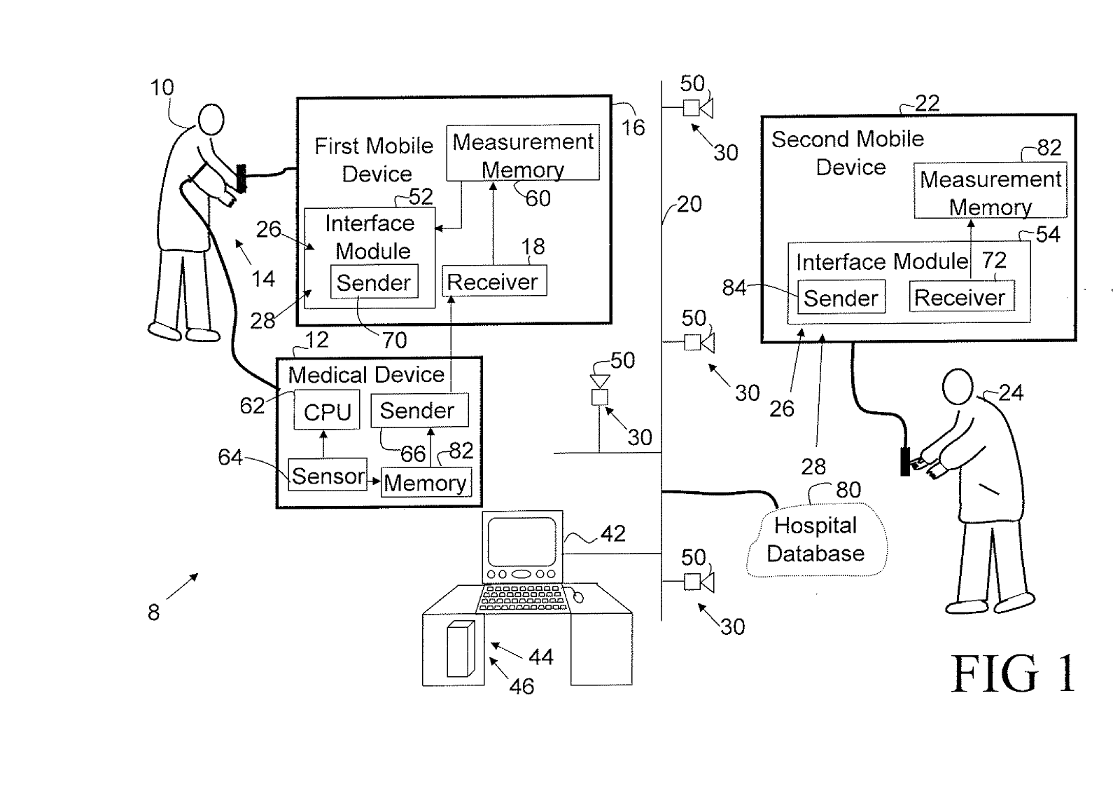

FIG. 1 is a diagrammatic illustration of a patient monitoring system.

With reference to FIG. 1, in a patient monitoring system 8, vital signs measurements or health related parameters, such as temperature, blood pressure, weight, heart rate and rhythm, respiration, oxygen, and the like, are monitored from one or more patients 10 using a medical or measurement device or devices 12. In one embodiment, the medical devices 14 associated with the same patient form a body sensor network or BSN 14. Each patient 10 wears a first or patient mobile device 16 such as an IP phone which includes a short range communication interface such as a receiver 18 to wirelessly receive measurements taken by each measurement device 12. The patient mobile device 16 further wirelessly communicates the measurements via a local area network 20 to a second or physician mobile device 22 such as an IP phone worn by a physician or other medical professional 24.

Generally, the IP phone 16 uses a general-purpose communication protocol to communicate voice or digital information via a best effort type communication network such as a private phone network, local area network (LAN) or the Internet. An example of a suitable IP phone is a unified wireless IP phone 7920 manufactured by Cisco which uses IEEE 802.11b protocol. In one embodiment, the patient's and clinician's mobile devices 16, 22 are preconfigured to communicate with one another as, for example, when the patient is initially checked in at the hospital and the attending physician is assigned to the patient. In one embodiment, the first and second IP phones are configured into a virtual local area network (VLAN). For example, the network administrator configures the first and second mobile devices into the VLAN through software. For example, when the first mobile device moves to another location, the first mobile device stays within the same VLAN without the need for any hardware reconfiguration.

Of course, the mobile devices 16, 22 can be cellular phones, palm computers, notebook computers, laptop computers, held-hand devices, PDAs, pagers, desktop computers, or any other devices which can be configured for wireless communications with the local area network of the hospital or the Internet. The first and second mobile devices 16, 22 each includes an associated communication interface including appropriate software and hardware 26, 28 to communicate with the local area network or any other appropriate communication net.

Generally, the local area network 20 couples multiple access points or stations 30 (only four access points are shown for simplicity of illustration), which are distributed throughout a defined area or space to provide wireless service to the mobile devices 16, 22 which operate within the space and are configured to communicate with the access points 30. Each access point 30 has a finite operational range, which is typically 30-50 meters and operates within its own dedicated radio channel with a known radiofrequency.

The access points 30 are wired or otherwise connected into the wired network infrastructure or the local area network (LAN) 20. A central computer 42, which is connected to the local area network 20 and includes associated software means 44 and hardware means or processor 46, oversees the operations of the monitoring system 8 and, for example, provides an interface to various systems and/or applications which are available within the local area network 20.

Each access point 30 includes an antenna or receiving/transmitting means 50 to communicate bi-directionally with the mobile devices 16, 22. E.g., the access points 30 at least receive, buffer, and transmit data between the mobile devices 16, 22 and the wired network 20. Each mobile device 16, 22 includes associated transceivers or interface modules 52, 54 which provide an interface between the mobile devices 16, 22 and the receiving/transmitting means 50.

With continuing reference to FIG. 1, the patient mobile device 16 includes at least a measurement memory 60 for storing results of the measurements. Of course, it is also contemplated that more information can be stored in the patient mobile device 16, for example, name, anamnesis, diagnosis, therapy and the like.

Each patient mobile device 16 is attached or carried in a close proximity to the patient's body. Likewise, the physician's mobile device 22 is attached or carried in close proximity of physician's body.

The medical device 12 typically includes a central processing unit (CPU) 62, and typically a sensor 64. In one embodiment, the medical device 12 includes a user interface for manual input of data. The medical device 12 takes the measurements via the sensor 64 or user interface and, in one embodiment, attaches a time stamp to the measurement. The measurement result is wirelessly sent via a sender 66 of the measurement device 12 to the receiver 18 of the first mobile device 16, for example, using a body coupled communication protocol. A sender 70 wirelessly sends the patient's data via the local area network 20 to a receiver 72 of the second mobile device 22 of the medical professional assigned to this particular patient. The medical professional, for example, receives the stored or real time measurements of the patient on request. Alternatively, the medical professional continuously receives patient's measurement results on the second mobile device 22. In one embodiment, the measurement data is stored in the measurement memory 60. In another embodiment, the measurement data of the patient 10 is stored in a hospital database 80. The measurement result at least includes the measurement values. In one embodiment, the measurement result includes other parameters such as date, time, type of the measurement device used, and other. Optionally, the measurement device 12 includes a memory 82 in which the measurements are stored for future communication. In one embodiment, the physician 24 retrieves the results from at least one of the measurement memory 60, medical device memory 82 and hospital database 80 by sending a request via a second mobile device sender 84. This allows the physician 24 to review the historical data of the patient 10. In one embodiment, the mobile devices 16, 22 include GPS subsystems which facilitate rapid location functions.

In one embodiment, a positioning system enables medical staff to quickly find the patient they are looking for or/and the system to notify the nearest physician or nurse in case of a critical situation. This enhancement leads to a further increase in the efficiency of hospital staff.

When the measurements are determined by the CPU 62, or centrally at the hospital database to be critical, an audible or visible alarm is sent to the mobile device 22 of the attending physician or other medical personnel. If the condition is urgent and the attending physician is located too far from the patient, an alarm can also be sent to the closest physician or other medical professionals. Using the voice protocol, the physician can quickly establish voice communications with the patient as well as with other medical professionals responding to the alarm.

In one embodiment, the patients are monitored at another location, e.g., when the patients have WLAN coverage at home or in commercial, educational, commercial buildings, or other locations with a publicly accessible WLAN internet connection. The home and hospital WLANs interconnect over the internet. An important cost reduction is involved through the use of IP-based vital data transmission. Furthermore, cheap IP phone calls are also possible for personal contact between patient and physician. The vital sign monitoring in combination with the cheap phone call possibility enables a dramatic reduction of hospital and practice visits, since such visits can be restricted to those necessary cases (e.g. critical situations or cases where additional medical tests are required). In another embodiment, the mobile devices are dual IP phone/cell phone units. This provides a redundant backup communication system when direct IP phone communication is not available.

Physicians can either continuously receive the patient's vital signs or consult the patient's vital signs after having received an alarm notification. By adding a storage capability to the system, physicians can also receive and examine the patient's past vital signs, with which the physicians can judge the development of the patient or better evaluate critical situations that aroused in the past.

In this manner patients are mobile and completely free of cables (as opposed to existing telemetry solutions). The patient only wears one or more small measurement devices under his/her garments and carries an IP phone. Of course, it is contemplated that the mobile devices 16, 22 can be incorporated into the garments, attached to the garments, coupled to the garments of the patient or clinician, and the like. This accelerates the recovery and raises the comfort level of the patients. Physicians are also mobile, which maximizes their work output. Patients' vital signs can be checked from hallways, elevators, cafeterias, or most anywhere the physician happens to be. Patient safety is increased for there is no need for a physician to be in close proximity to evaluate the vital parameters. An IP telephone call to the patient enables physicians to retrieve verbal information that helps to assess the patient's condition. This increases the quality of patient care. The (re)utilization of the hospital WLAN infrastructure allows for very cost-efficient implementations of the above. Seamless transitions between different hospital areas where patient monitoring is needed is enabled (the BSN at the patient's body need not be replaced).

In one embodiment, a plurality of patients is assigned to the medical professional. Typically, when each patient is admitted to the health care facility, a corresponding unique identification number is configured for this patient. The configured unique patient's identification number is associated to a corresponding patient record in the hospital database. The patient's identifier is associated with the patient's mobile device. Alternatively, the patient's identifier is associated with the transmitted measurement results. Each physician or medical professional is assigned a unique physician's identifier as well. The unique identifiers allow relating the measurement results of the specific patient to the assigned clinician. In one embodiment, a graphical user interface facilitates association of each patient's identifier to the attending physician's identifier and corresponding attending physician's mobile device. Of course, it is contemplated that the patients' mobile devices can be associated with the physician's mobile device by any other appropriate means, such as software program or algorithm.

The invention has been described with reference to the preferred embodiments. Modifications and alterations may occur to others upon reading and understanding the preceding detailed description. It is intended that the invention be constructed as including all such modifications and alterations insofar as they come within the scope of the appended claims or the equivalents thereof.

1. A patient monitoring system for monitoring health related parameters of a patient, the system comprising:
a medical device for obtaining measurements of the health related parameters of the patient;
a first mobile device, associated with the patient, for wirelessly collecting and transmitting the health related parameters of the patient; and
a second mobile device, in operative communication with first mobile device, for receiving the transmitted health related parameters of the patient.

2. The system as set forth in claim 1, wherein at least one of the first and second mobile device includes an IP phone.

3. The system as set forth in claim 1, wherein at least one of the first and second mobile device includes:
an interface module which is configured for communications with the network.

4. The system as set forth in claim 1, wherein:
the medical device includes a sensor for sensing at least one parameter of the patient, and a short range or body coupled communication sender;
the first mobile device includes a receiver for receiving the short range or body coupled communication from the medical device, an IP interface module programmed with software for wireless communication with a local area network, and a memory; and
the second mobile device includes one of an IP phone, a palm notebook, or laptop computer with a wireless interface, or a PDA or other mobile device which communicates wirelessly with the local area network directly or through an internet interconnection.

5. The system as set forth in claim 1, wherein the medical device includes:
a sensor for measuring a physiological parameter of the patient.

6. The system as set forth in claim 1, wherein at least one of the first and second mobile devices includes:
a measurement memory for storing at least the measurement results.

7. The system as set forth in claim 1, further including:
a database from which the second mobile device withdraws the patient's measurements.

8. The system as set forth 1, further including:
a body sensor network which includes a plurality of wireless medical devices, operatively connected to the patient which wireless medical devices collect and transfer information related to the patient's health.

9. A monitoring method, comprising:
assigning wireless first and second mobile devices correspondingly to a subject and a reviewer;
associating the first mobile device to a medical measurement device which is linked to a corresponding subject;
measuring a health related parameter of the subject with the medical measurement device;
collecting the results of the measurements with the first mobile device; and
transmitting the results of the measurements of the subject to the second mobile device.

10. The method as set forth in claim 9, wherein the first and second mobile devices each have a unique IP address and wherein:
the assigning step includes storing the IP address of the first mobile device in the second mobile device and the IP address of the second mobile device in the first mobile device;
with the first mobile device the transmitting step includes wirelessly transmitting the measured health parameter and the second IP address to a local area network and wirelessly transmitting the measured health parameter and the second IP address to the second mobile device.

11. The method as set forth in claim 9, further including:
establishing a communication link between the first and second mobile devices via at least one of Internet, local area network, private phone network, or other network.

12. The method as set forth in claim 9, wherein at least one of the first mobile device and the first measurement device include a memory which stores the health parameter measurements, and further including:
monitoring the measured health parameters to determine if health parameters are in a critical range;
in response to determining that the measured health parameter is in a critical range, sending an alarm to the second mobile device;
in response to receiving the alarm, accessing the first mobile device from the second mobile device, displaying the health parameter measurements in real time on the second mobile device, and displaying selected stored health parameters on the second mobile device.

13. The method as set forth in claim 9, further including:
comparing the measured health parameters to a prespecified range which parameters include at least one of an Electrocardiogram (ECG), Electroencephalogram (EEG), an Electromyogram (EMG), an invasive blood pressure (BP), a non-invasive blood pressure (NiBP), pulse, cardiac output, respirations, blood oxygen (SpO₂), and core body temperature;
determining if the measured health parameters are out of range;
in response to determining that the measured health parameters are in the range, automatically displaying the health parameter measurements in real time on the second mobile device; and
in response to determining that the measured health parameters are out of range, continuing automatically displaying the health parameter measurements in real time on the second mobile device, displaying selected critical health parameters on the second mobile device, and generating one of a video and audio alarm for medical personnel, which alarm includes at least one of text, graphics, sound, vibration, and color accents.

14. The method as set forth in claim 9, further including:
receiving the transmitted health related parameters of the subject by at least one of a clinician assigned to the subject, a third party and a clinician other than the assigned clinician who is physically closer to the subject than the assigned clinician.

15. The method as set forth in claim 9, further including:
measuring a physiological parameter of the subject with a sensor.

16. The method as set forth in claim 9, further including:
storing the measurement results at least in one of:
a medical device memory,
a first mobile device memory,
a second mobile device memory,
a hospital database, and
a server.

17. A patient monitoring system for monitoring health related parameters of a patient, the system comprising:
a medical device for obtaining measurements of the health related parameters of the patient;
a first mobile device, associated with the patient, for wirelessly collecting and transmitting the health related parameters of the patient for review;
a second mobile device, associated with the first mobile device and a clinician, for receiving the transmitted health related parameters of the patient; and
a network, in operative communication with the first and second mobile devices, for receiving the health related parameters of the patient from the first mobile device and transmitting the health related parameters of the patient to the second mobile device.

18. The system as set forth in claim 17, wherein at least one of the first and second mobile device includes at least one of an IP phone, cellular phone, a laptop computer, and a pager.

19. A method for monitoring a plurality of patients, comprising:
assigning an identification code to each patient which identification code uniquely identifies the patient;
assigning first mobile devices to selected patients;
associating each patient's identification code with the respective assigned first mobile device;
assigning an identification code to a clinician which identification code uniquely identifies the clinician;
associating the identification code of each patient with the selected clinician;
assigning a second mobile device to a selected physician;
associating the physician's identification code with the assigned second mobile device;
measuring a physiological function of each of the plurality of patients; and
transmitting results of the measurements to the second mobile device.
